(19) United States
(12) Patent Application Publication
(10) Pub. No.: US 2026/0360776 A1
(43) Pub. Date: Nov. 12, 2026

(54) LIQUID HYDROGEN-BASED FUEL CELL POWER TRAIN SYSTEM

(71) Applicant: LIBECO ENC Co., LTD, Anyang-si, Gyeonggi-do (KR)

(72) Inventors: Yong Seok KIM, Anyang-si, Gyeonggi-do (KR); Tae Wook KIM, Anyang-si, Gyeonggi-do (KR); Dong Ju LEE, Anyang-si, Gyeonggi-do (KR); Jun Woo KANG, Anyang-si, Gyeonggi-do (KR); Young Rock LEE, Anyang-si, Gyeonggi-do (KR)

(73) Assignee: LIBECO ENC Co., LTD, Anyang-si, Gyeonggi-do (KR)

(21) Appl. No.: 19/470,082

(22) PCT Filed: Oct. 23, 2023
(86) PCT No.: PCT/KR2023/016471

§ 371 Date: Sep. 29, 2025

(51) Int. Cl. H01M 8/04029; B60L 50/75; H01M 8/04014; H01M 8/04082; H01M 8/04701; H01M 8/04746

(52) U.S. Cl. CPC H01M 8/04029; B60L 50/75; H01M 8/04014; H01M 8/04201; H01M 8/04708; H01M 8/04753; H01M 8/04768; H01M 2250/20

(57) ABSTRACT

The present invention provides a liquid hydrogen-based fuel cell power train system including a motor configured to generate a driving force of a liquid hydrogen-based fuel cell power engine, a fuel cell stack configured to convert chemical energy of hydrogen and oxygen into electrical energy and supply the electrical energy to the motor, a hydrogen tank configured to accommodate hydrogen supplied to the fuel cell stack through a hydrogen supply path, and a coolant circulation system including a plurality of cooling paths that cool the fuel cell stack and circulate a coolant, whose temperature has increased, to re-cool the coolant, wherein the coolant circulation system performs switching control of the cooling paths, along which the coolant flows, to deal with an operational situation of the fuel cell stack.

### TECHNICAL FIELD

The present invention relates to a liquid hydrogen-based fuel cell power train system, and more particularly, to a liquid hydrogen-based fuel cell power train system that performs switching control of cooling paths, along which a coolant flows, to deal with an operational situation of a fuel cell stack, thereby enabling efficient thermal management.

### BACKGROUND ART

In recent years, the automobile industry has focused on development and commercialization of eco-friendly vehicles to address air pollution and climate change problems.

Also, currently available eco-friendly vehicles include electric vehicles, hydrogen-fueled vehicles, hybrid vehicles, and the like.

Among the above, hydrogen-fueled vehicles are classified into hydrogen fueled internal combustion engine vehicles that generate a driving force using hydrogen itself as a fuel and hydrogen-fueled fuel cell vehicles that supply hydrogen to fuel cells to generate electricity and use the electricity to generate a driving force.

Since hydrogen-fueled fuel cell vehicles are so far considered to have higher safety and efficiency than hydrogen-fueled internal combustion engine vehicles, the future hydrogen-fueled vehicle market is predicted to be constructed based on hydrogen-fueled fuel cell vehicles.

However, hydrogen-fueled fuel cell vehicles have a problem in that thermal management is not easy due to a large amount of heat being generated in a fuel cell stack which is a main body of fuel cells.

Currently, a water-cooling type cooling device that performs cooling using a coolant for thermal management of a fuel cell stack is applied to hydrogen-fueled fuel cell vehicles.

However, a situation in which a fuel cell stack is overheated often occurs during operation of hydrogen-fueled fuel cell vehicles, and in such a situation, it is difficult to perform thermal management of the fuel cell stack with only the conventional cooling device.

In addition, since the cooling device is always operated at a uniform level even when the optimal temperature of the fuel cell stack is maintained, fuel efficiency of hydrogen-fueled fuel cell vehicles is reduced.

Also, boil-off gas (BOG) is inevitably generated when liquid hydrogen is stored in hydrogen-fueled fuel cell vehicles, and conventionally, the BOG generated in a storage container has been handled by being discharged to the outside.

However, in such a case, energy is wasted due to the uselessly discarded BOG, and a problem may occur in terms of safety when the discharge of the BOG is performed in a closed space.

### DISCLOSURE OF THE INVENTION

### Technical Goals

The present invention is directed to a liquid hydrogen-based fuel cell power train system that performs switching control of cooling scenarios to deal with an operational situation of a fuel cell stack, thereby enabling efficient thermal management.

Objectives of the present invention are not limited to the above-mentioned objective, and other unmentioned objectives should be clearly understood by those of ordinary skill in the art from the description below.

### Technical Solutions

According to an aspect of the present invention, there is provided a liquid hydrogen-based fuel cell power train system including a motor configured to generate a driving force of a liquid hydrogen-based fuel cell power engine, a fuel cell stack configured to convert chemical energy of hydrogen and oxygen into electrical energy and supply the electrical energy to the motor, a hydrogen tank configured to accommodate hydrogen supplied to the fuel cell stack through a hydrogen supply path, and a coolant circulation system including a plurality of cooling paths that cool the fuel cell stack and circulate a coolant, whose temperature has increased, to recool the coolant, wherein the coolant circulation system performs switching control of the cooling paths, along which the coolant flows, to deal with an operational situation of the fuel cell stack.

In addition, the liquid hydrogen-based fuel cell power train system of the present invention may further include a heat exchanger configured to perform a heat exchange between the hydrogen supplied to the fuel cell stack and the coolant circulating through the coolant circulation system and a radiator configured to dissipate heat of the coolant circulating through the coolant circulation system to the outside.

Also, the coolant circulation system may include a first cooling path configured to allow a coolant that has passed through the fuel cell stack to circulate without passing through the heat exchanger and the radiator, a second cooling path configured to allow the coolant circulating through the first cooling path to circulate by passing through the heat exchanger, and a third cooling path configured to allow the coolant circulating through the first cooling path to circulate by passing through the radiator.

Here, in a case where a coolant that has passed through fuel cells is able to maintain a temperature in a reference temperature range through cooling by natural cooling of the liquid hydrogen-based fuel cell power engine, the coolant circulation system may supply the coolant at a first flow rate and control the coolant to circulate only through the first cooling path or control the coolant to circulate through the first cooling path and the second cooling path.

Here, the liquid hydrogen-based fuel cell power train system of the present invention may further include a temperature control device configured to control a temperature of the hydrogen supplied to the fuel cell stack through the hydrogen supply path, and here, in the case where the coolant is controlled to circulate only through the first cooling path, the temperature of the hydrogen may be separately controlled through the temperature control device.

Also, in a case where the coolant that has passed through the fuel cells is not able to maintain a temperature in the reference temperature range through the heat exchanger and cooling by natural cooling of the liquid hydrogen-based fuel cell power engine, the coolant circulation system may supply the coolant at a second flow rate higher than the first flow rate and control the coolant to circulate through the first cooling path, the second cooling path, and the third cooling path.

Also, the radiator may include a blower fan, and in a case where the coolant that has passed through the fuel cells is not able to maintain a temperature in the reference temperature range through the heat exchanger, the radiator, and cooling by natural cooling of the liquid hydrogen-based fuel cell power engine, the coolant circulation system may supply the coolant at a third flow rate higher than the second flow rate and drive the blower fan while controlling the coolant to circulate through the first cooling path, the second cooling path, and the third cooling path.

Meanwhile, the liquid hydrogen-based fuel cell power train system of the present invention may further include a pressure control device configured to control a pressure of the hydrogen supplied to the fuel cell stack from the hydrogen tank.

In addition, the liquid hydrogen-based fuel cell power train system of the present invention may further include a branched path branched from the hydrogen supply path and a buffer tank provided in the branched path to store hydrogen and a boil-off gas (BOG).

Also, in a case where an amount of hydrogen supplied from the hydrogen tank is larger than an amount of hydrogen used in the fuel cell stack, the excess hydrogen may be controlled to flow to the branched path and be stored in the buffer tank.

Also, in a case where an amount of hydrogen supplied from the hydrogen tank is less than an amount of hydrogen used in the fuel cell stack, the deficient hydrogen may be controlled to be supplied from the buffer tank to the hydrogen supply path.

Meanwhile, the liquid hydrogen-based fuel cell power train system of the present invention may further include a BOG-only fuel cell stack configured to convert chemical energy of hydrogen and oxygen into electrical energy using the BOG stored in the buffer tank and supply the electrical energy to the motor.

Here, in a case where an amount of hydrogen supplied from the hydrogen tank is less than an amount of hydrogen used in the fuel cell stack, the BOG of the buffer tank may be supplied to the hydrogen supply path and then supplied to the BOG-only fuel cell stack.

Alternatively, the branched path may be directly connected from the buffer tank to the BOG-only fuel cell stack, and in a case where an amount of hydrogen supplied from the hydrogen tank is less than an amount of hydrogen used in the fuel cell stack, the BOG of the buffer tank may be directly supplied from the buffer tank to the BOG-only fuel cell stack.

In addition, the liquid hydrogen-based fuel cell power train system of the present invention may further include a battery configured to supply electrical energy to the motor together with the fuel cell stack, and in such a case, the fuel cell stack may allow excess electrical energy to be supplied to the battery and stored.

### Advantageous Effects

A liquid hydrogen-based fuel cell power train system of the present invention has an advantage in that, since a coolant circulation system including a plurality of cooling paths that cool a fuel cell stack and circulate a coolant, whose temperature has increased, to re-cool the coolant is provided, switching control of cooling paths, along which a coolant flows, can be performed to deal with an operational situation of the fuel cell stack, and thus thermal management of the fuel cell stack can be efficiently performed.

Also, the present invention has an advantage in that, since the amount of supplied hydrogen can be controlled to deal with an operational situation of the fuel cell stack, fuel efficiency of a liquid hydrogen-based fuel cell power engine can be further increased.

Advantageous effects of the present invention are not limited to the above-mentioned advantageous effects, and other unmentioned advantageous effects should be clearly understood by those of ordinary skill in the art from the claims below.

### BRIEF DESCRIPTION OF THE DRAWINGS

FIG. 1 is a view schematically illustrating an organic connection structure between components constituting a liquid hydrogen-based fuel cell power train system according to a first embodiment of the present invention;

FIGS. 2 and 3 are views illustrating a coolant circulation path in a case where a fuel cell stack is able to maintain a temperature in a reference temperature range through air cooling by natural cooling of a liquid hydrogen-based fuel cell power engine in the liquid hydrogen-based fuel cell power-train system according to the first embodiment of the present invention;

FIG. 4 is a view illustrating a coolant circulation path in a case where the fuel cell stack is not able to maintain a temperature in the reference temperature range through a radiator and air cooling by natural cooling of the liquid hydrogen-based fuel cell power engine in the liquid hydrogen-based fuel cell power train system according to the first embodiment of the present invention;

FIG. 5 is a view illustrating a coolant circulation path in a case where the fuel cell stack is not able to maintain a temperature in the reference temperature range through a heat exchanger, the radiator, and air cooling by natural cooling of the liquid hydrogen-based fuel cell power engine in the liquid hydrogen-based fuel cell power train system according to the first embodiment of the present invention;

FIG. 6 is a view schematically illustrating an organic connection structure between components constituting a liquid hydrogen-based fuel cell power train system according to a second embodiment of the present invention; and

FIG. 7 is a view schematically illustrating an organic connection structure between components constituting a liquid hydrogen-based fuel cell power train system according to a third embodiment of the present invention.

### DETAILED DESCRIPTION OF EXEMPLARY EMBODIMENTS

In the present specification, when a certain component (or region, layer, part, etc.) is mentioned as being “on,” “connected to,” or “coupled to” another component, it means that the component may be directly disposed on/connected to/coupled to the other component, or a third component may be disposed therebetween.

Like reference numerals refer to like components. Also, in the drawings, thicknesses, proportions, and sizes of components are exaggerated for effective description of technical content.

The term “and/or” includes all of one or more combinations that may be defined by associated configurations.

Terms such as “first” and “second” may be used to describe various components, but the components should not be limited by the terms. The terms are only used for the purpose of distinguishing one component from another component. For example, without departing from the scope of rights of the present invention, “first component” may be referred to as “second component,” and likewise, “second component” may also be referred to as “first component.” A singular expression includes a plural expression unless the context clearly indicates otherwise.

Also, terms such as “under,” “below,” “on,” and “above” are used to describe correlations between configurations illustrated in the drawings. The terms are relative concepts, and description is given based on directions indicated in the drawings.

Unless defined otherwise, all terms including technical or scientific terms used herein have the same meaning as commonly understood by those of ordinary skill in the art to which the present invention pertains. Also, terms, such as those defined in commonly used dictionaries, should be interpreted to have meanings consistent with their meanings in the context of the relevant art and are explicitly defined herein unless construed in an idealized or overly formal sense.

Terms such as “include” or “have” are intended to designate the presence of features, numbers, steps, operations, components, parts, or combinations thereof described herein and should not be understood as precluding the possibility of presence or addition of one or more other features, numbers, steps, operations, components, parts, or combinations thereof.

Hereinafter, embodiments of the present invention will be described in detail with reference to the drawings.

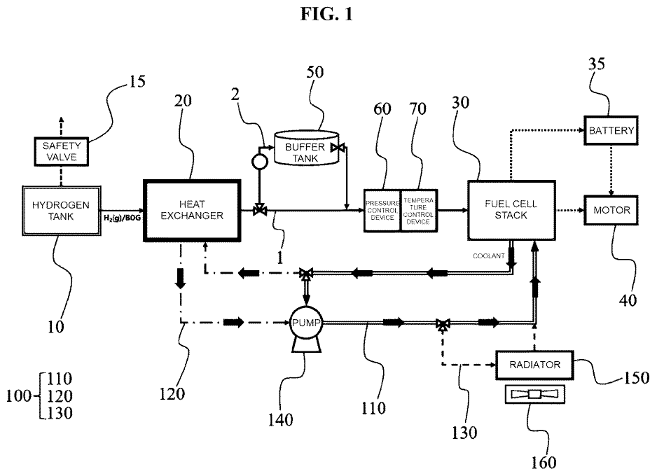

FIG. 1 is a view schematically illustrating an organic connection structure between components constituting a liquid hydrogen-based fuel cell power train system according to a first embodiment of the present invention.

A liquid hydrogen-based fuel cell power train system applied to fuel cell vehicles is described as an example in the present embodiment, but a target to which the present invention is applied is not limited to vehicles, and the present invention may also be applied to ships, urban air mobility (UAM), construction equipment, and the like without limitations as long as a fuel cell power train system generates power based on liquid hydrogen. As illustrated in FIG. 1, the liquid hydrogen-based fuel cell power train system according to the present invention includes a motor 40, a fuel cell stack 30, a hydrogen tank 10, and a coolant circulation system 100.

Also, in the present embodiment, the liquid hydrogen-based fuel cell power train system may, in addition to the components listed above, further include a heat exchanger 20, a radiator 150, a temperature control device 70, a pressure control device 60, a buffer tank 50, a battery 35, and a safety valve 15.

The motor 40 includes a stator and a rotor, rotates the rotor to generate a driving force, and transmits the driving force to a wheel of a liquid hydrogen-based fuel cell power engine.

Also, the fuel cell stack 30 is a component that converts chemical energy of hydrogen and oxygen into electrical energy and supplies the electrical energy to the motor 40.

Since driving principles of the motor 40 and the fuel cell stack 30 are obvious to those of ordinary skill in the art, additional descriptions thereof will be omitted.

The hydrogen tank 10 is provided to store hydrogen supplied to the fuel cell stack 30 through a predetermined hydrogen supply path 1.

Hydrogen in the form of a liquid may be stored in the hydrogen tank 10, and hydrogen supplied to the fuel cell stack 30 may be converted into a gaseous form and supplied through the hydrogen supply path 1. Such a phase change process may be performed by the heat exchanger 20 which will be described below.

The coolant circulation system 100 includes a plurality of cooling paths 110, 120, and 130 along which a coolant for cooling the fuel cell stack circulates. That is, the plurality of cooling paths 110, 120, and 130 may circulate a coolant, whose temperature has increased in a process of cooling the fuel cell stack 30, to re-cool the coolant.

Also, in the present embodiment, the coolant circulation system 100 performs switching control of the cooling paths 110, 120, and 130, along which the coolant flows, to deal with an operational situation of the fuel cell stack 30.

In the present embodiment, the coolant circulation system 100 includes a first cooling path 110, a second cooling path 120, and a third cooling path 130, which will be described below.

The heat exchanger 20 is provided to perform a heat exchange between the hydrogen supplied to the fuel cell stack 30 and the coolant circulating through the coolant circulation system 100. Specifically, in the present embodiment, the heat exchanger 20 has a form that performs a heat exchange between the hydrogen supply path 1 and the second cooling path 120 of the coolant circulation system 100.

The radiator 150 is provided to dissipate heat of the coolant circulating through the coolant circulation system 100 to the outside. Specifically, in the present embodiment, the radiator 150 has a form that is provided in the third cooling path 130 to dissipate heat of the coolant introduced into the third cooling path 130 to the outside.

The radiator 150 is not strictly only a radiator in a narrow sense and the concept encompasses all devices performing similar functions.

For example, the radiator 150 may be a seawater heat exchanger, a seawater heat exchanger pump, or the like in a case where the fuel cell power train system is applied to a ship, and the radiator 150 may also have a configuration that performs the same function in construction equipment or the like.

The temperature control device 70 serves to control a temperature of the hydrogen supplied to the fuel cell stack 30 through the hydrogen supply path 1, and the pressure control device 60 serves to control a pressure of the hydrogen supplied to the fuel cell stack 30 through the hydrogen supply path 1.

The buffer tank 50 is provided in a branched path 2, which is branched from the hydrogen supply path 1 and then merged therewith again, to store a boil-off gas (BOG) generated in a small amount together with hydrogen. Here, a 3-way valve for controlling a flow direction of the hydrogen and BOG may be provided at a branching point of the branched path 2.

Also, the BOG collected through the buffer tank 50 may be suitably supplied to fuel cells while the liquid hydrogen-based fuel cell power engine is stopped or driving of other driving devices is paused, and electrical energy generated in this way may be stored in the battery 35. Accordingly, the present invention can prevent energy loss of the liquid hydrogen-based fuel cell power engine.

The battery 35 is provided to supply electrical energy to the motor 40 together with the fuel cell stack 30.

Meanwhile, as described above, in the present embodiment, the coolant circulation system 100 includes the first cooling path 110, the second cooling path 120, and the third cooling path 130.

The first cooling path 110 allows a coolant that has passed through the fuel cell stack 30 to circulate without passing through the heat exchanger 20 and the radiator 150.

The second cooling path 120 allows the coolant circulating through the first cooling path 110 to circulate by passing through the heat exchanger. To this end, a 3-way valve for controlling a flow direction of the coolant may be provided at a branching point of the first cooling path 110 and the second cooling path 120.

The third cooling path 130 allows the coolant circulating through the first cooling path 110 to circulate by passing through the radiator 150. To this end, a 3-way valve for controlling a flow direction of the coolant may be provided at a branching point of the first cooling path 110 and the third cooling path 130.

Also, in the present embodiment, the branching point and a re-merging point of the second cooling path 120 and the first cooling path 110 may be positioned upstream of the branching point and a re-merging point of the third cooling path 130 and the first cooling path 110.

As described above, it can be seen that the liquid hydrogen-based fuel cell power train system of the present invention includes the coolant circulation system 100 including the plurality of cooling paths 110, 120, and 130 that cool the fuel cell stack 30 and circulate a coolant, whose temperature has increased, to re-cool the coolant.

Here, in the present invention, since switching control of the cooling paths 110, 120, and 130, along which a coolant flows, is performed to deal with an operational situation of the fuel cell stack 30, thermal management of the fuel cell stack 30 can be efficiently performed.

Hereinafter, control scenarios according to various operational situations of the fuel cell stack 30 will be described in detail.

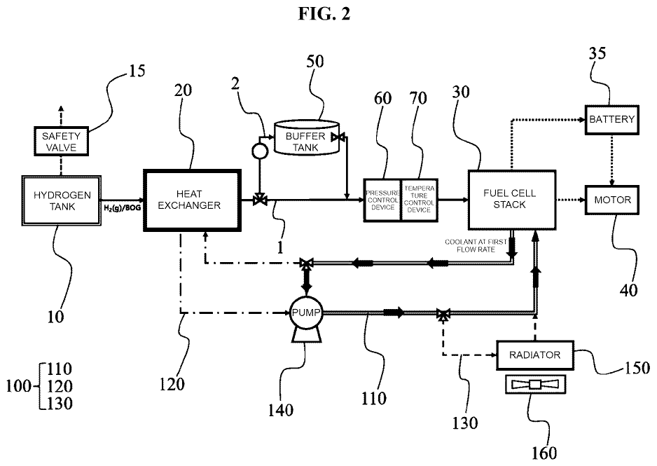

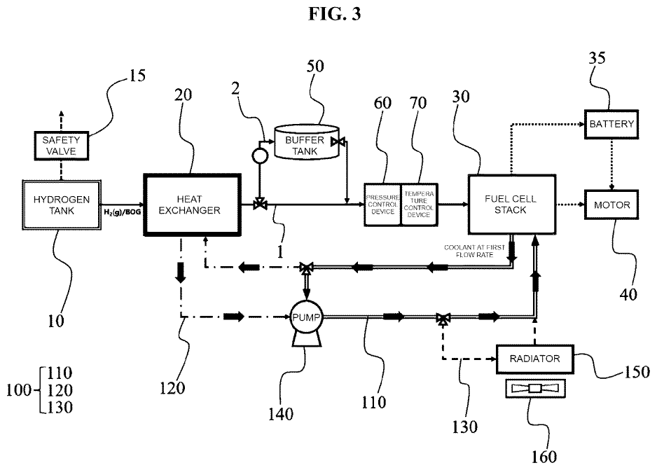

FIGS. 2 and 3 are views illustrating a first control scenario of the liquid hydrogen-based fuel cell power train system according to the first embodiment of the present invention.

The first control scenario of the present embodiment is a control scenario in a case where a coolant that has passed through fuel cells is able to maintain a temperature in a reference temperature range through cooling by natural cooling of the liquid hydrogen-based fuel cell power engine. For example, the first control scenario may be a control scenario in a case where a vehicle travels at a constant speed, that is, a case where a vehicle speed is sufficient and sudden acceleration does not occur.

Here, “natural cooling” refers to a situation in which a coolant can be cooled by controlling a flow rate of the coolant by an outside air temperature or traveling wind generated in a traveling process of the liquid hydrogen-based fuel cell power engine without using a separate cooling device.

In this way, in the case where the coolant that has passed through the fuel cells is able to maintain a temperature in the reference temperature range through cooling by natural cooling of the liquid hydrogen-based fuel cell power engine, the coolant circulation system 100 may supply the coolant at a first flow rate, and as illustrated in FIG. 2, control a pump 140 and a valve so that the coolant circulates only through the first cooling path 110.

That is, in the case where the coolant that has passed through the fuel cells is able to maintain a temperature in the reference temperature range through cooling by natural cooling of the liquid hydrogen-based fuel cell power engine, energy consumption may be minimized by causing the coolant to circulate without passing through the heat exchanger 20 and the radiator 150.

Also, the first flow rate is a flow rate lower than a second flow rate and a third flow rate which will be described below in relation to a second control scenario and a third control scenario.

Alternatively, in the first control scenario, in the case where the coolant that has passed through the fuel cells is able to maintain a temperature in the reference temperature range through cooling by natural cooling of the liquid hydrogen-based fuel cell power engine, the coolant circulation system 100 may supply the coolant at the first flow rate, and as illustrated in FIG. 3, control the pump 140 and the valve so that the coolant circulates through the first cooling path 110 and the second cooling path 120.

In such a case, the coolant is introduced from the first cooling path 110 into the second cooling path 120 and passes through the heat exchanger 20.

Also, in the case where the coolant is controlled to circulate only through the first cooling path 110, the temperature of the hydrogen supplied through the hydrogen supply path 1 may be separately controlled by the temperature control device 70.

This is because a heat exchange between the hydrogen and the coolant does not occur in the heat exchanger 20, and a temperature rise and gasification of the hydrogen due to the coolant do not occur.

Also, in the first control scenario, a method in which cold heat of the hydrogen flowing through the hydrogen supply path 1 is stored in a separately configured heat storage line, and the cold heat is utilized in electronic equipment or the like may also be applied.

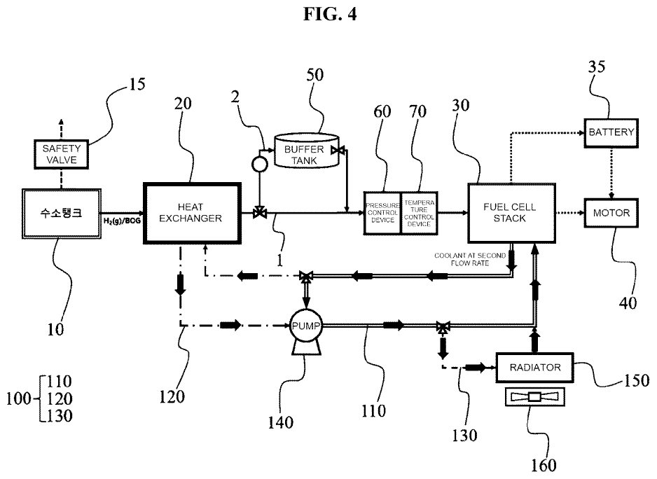

Next, FIG. 4 is a view illustrating the second control scenario of the liquid hydrogen-based fuel cell power train system according to the first embodiment of the present invention.

The second control scenario of the present embodiment is a control scenario in a case where the coolant that has passed through the fuel cells is not able to maintain a temperature in the reference temperature range through the heat exchanger 20 and cooling by natural cooling of the liquid hydrogen-based fuel cell power engine. For example, the second control scenario may be a control scenario in a case where a vehicle travels at a high speed or is stopped.

That is, the second control scenario may be performed in the case where the coolant is not able to maintain a temperature in the reference temperature range even when passing through the heat exchanger 20 after passing through the second cooling path 120 as in the first control scenario.

In this way, in the case where the coolant that has passed through the fuel cells is not able to maintain a temperature in the reference temperature range through the heat exchanger 20 and cooling by natural cooling of the liquid hydrogen-based fuel cell power engine, the coolant circulation system 100 may supply the coolant at the second flow rate higher than the first flow rate, and as in FIG. 4, control the coolant to circulate through the first cooling path 110, the second cooling path 120, and the third cooling path 130.

That is, in the case where the coolant that has passed through the fuel cells is not able to maintain a temperature in the reference temperature range through the heat exchanger 20 and cooling by natural cooling of the liquid hydrogen-based fuel cell power engine, the flow rate of the coolant may be increased, and the coolant may be cooled by circulating through both the heat exchanger 20 and the radiator 150.

By this process, the hydrogen flowing through the hydrogen supply path 1 undergoes a temperature rise and gasification, and the coolant flowing through the second cooling path 120 is cooled by cold heat of the hydrogen. Also, the coolant that has passed through the second cooling path 120 is introduced into the first cooling path 110 again and flows toward the fuel cell stack 30.

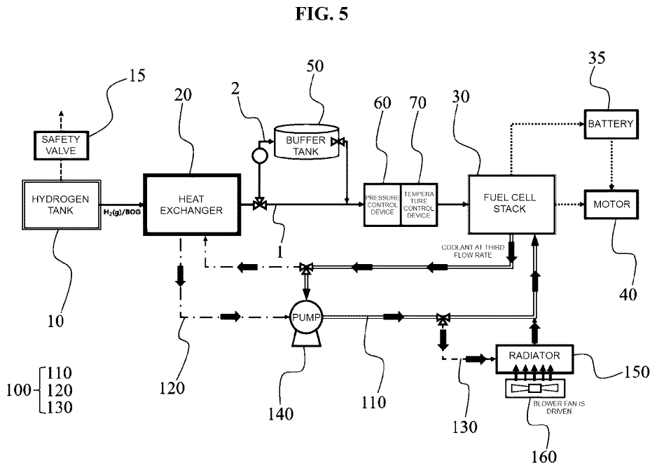

Next, FIG. 5 is a view illustrating the third control scenario of the liquid hydrogen-based fuel cell power train system according to the first embodiment of the present invention.

The third control scenario of the present embodiment is a control scenario in a case where the coolant that has passed through the fuel cells is not able to maintain a temperature in the reference temperature range through the heat exchanger 20, the radiator 150, and cooling by natural cooling of the liquid hydrogen-based fuel cell power engine. For example, the third control scenario may be a control scenario in a case where a vehicle travels in an overheated state, suddenly accelerates, or is stopped, and thus cooling is more difficult to perform smoothly with only air cooling compared to the second control scenario.

That is, the third control scenario may be performed in the case where the fuel cell stack 30 is not able to maintain a temperature in the reference temperature range even when the coolant passes through the second cooling path 120 and then undergoes a heat exchange with the hydrogen in the heat exchanger 20 as in the second control scenario and passes through the third cooling path 130 and then is cooled through the radiator.

In this way, in the case where the coolant that has passed through the fuel cells is not able to maintain a temperature in the reference temperature range through the heat exchanger 20, the radiator 150, and cooling by natural cooling of the liquid hydrogen-based fuel cell power engine, the coolant circulation system 100 may supply the coolant at the third flow rate higher than the second flow rate, and as in FIG. 5, control the coolant to circulate through the first cooling path 110, the second cooling path 120, and the third cooling path 130.

Also, in addition, a blower fan 160 of the radiator 150 may be driven to further decrease the temperature of the coolant flowing through the third cooling path 130.

As described above, it can be seen that, in the present invention, by performing switching control of the cooling paths 110, 120, and 130, along which a coolant flows, to deal with an operational situation of the fuel cell stack 30, thermal management of the fuel cell stack 30 can be efficiently performed.

Meanwhile, as described above, in the present embodiment, the liquid hydrogen-based fuel cell power train system may include the branched path 2 branched from the hydrogen supply path and then merged therewith again and the buffer tank 50 provided in the branched path 2 to store hydrogen and BOG.

Also, in the present embodiment, in a case where the amount of hydrogen supplied from the hydrogen tank 10 is larger than the amount of hydrogen used in the fuel cell stack 30, the excess hydrogen may be controlled to flow to the branched path 2 and be stored in the buffer tank 50.

Also, conversely, in a case where the amount of hydrogen supplied from the hydrogen tank 10 is less than the amount of hydrogen used in the fuel cell stack 30, the deficient hydrogen may be controlled to be supplied from the buffer tank 50 to the hydrogen supply path 1.

Generally, since liquid hydrogen has a very low temperature, it is extremely difficult to control liquid hydrogen, and thus, in a process of supplying hydrogen from the hydrogen tank 10, hydrogen may be supplied less or more than the amount of hydrogen used in the fuel cell stack 30.

However, in the present invention, using the buffer tank 50, the above-described case in which hydrogen is oversupplied or undersupplied can be easily dealt with, and thus a stable output may be maintained.

Also, in the present embodiment, the liquid hydrogen-based fuel cell power train system of the present embodiment further includes the battery 35 configured to supply electrical energy to the motor 40 together with the fuel cell stack 30. Accordingly, the fuel cell stack 30 may allow excess electrical energy to be supplied to the battery 35 and stored.

That is, in the present embodiment, by suitably controlling the amount of electrical energy supplied to the motor 40 from the fuel cell stack 30 and the battery 35, heat generated in the fuel cell stack 30 may be controlled.

Hereinafter, other embodiments of the present invention will be described. Here, in each of the embodiments described below, repeated description of components identical to those in the first embodiment described above will be omitted.

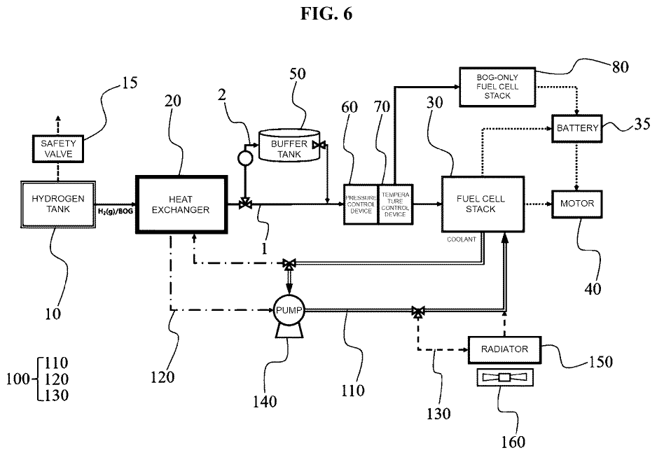

FIG. 6 is a view schematically illustrating an organic connection structure between components constituting a liquid hydrogen-based fuel cell power train system according to a second embodiment of the present invention.

The liquid hydrogen-based fuel cell power train system according to the second embodiment of the present invention illustrated in FIG. 6 includes the same components compared to the above-described first embodiment, except that a BOG-only fuel cell stack 80 is further included.

The BOG-only fuel cell stack 80 is a component configured to convert chemical energy of hydrogen and oxygen into electrical energy using the BOG stored in the buffer tank 50 and supply the electrical energy to the motor 40.

That is, the BOG-only fuel cell stack 80 may be provided separately from the fuel cell stack 30 and may receive only the BOG to generate electrical energy.

Also, in the present embodiment, in a case where the amount of hydrogen supplied from the hydrogen tank is less than the amount of hydrogen used in the fuel cell stack, the BOG of the buffer tank 50 is supplied to the hydrogen supply path 1 and then supplied to the BOG-only fuel cell stack 80.

More specifically, in the present embodiment, the BOG of the buffer tank 50 is supplied to the hydrogen supply path 1, passes through the pressure control device 60 and the temperature control device 70, and then flows from the temperature control device 70 toward the BOG-only fuel cell stack 80.

The separate BOG-only fuel cell stack 80 is provided additionally as described above because the BOG is generated irregularly, and in particular, the amount of generated BOG is very small relative to the amount of BOG necessary to add to the fuel cell stack 30.

When the irregularly generated BOG is added to the fuel cell stack 30 every time the BOG is generated, it is difficult for the fuel cell stack 30 to deal with irregularly added hydrogen each time, which may result in reduction of the service life of the fuel cell stack 30.

Also, since the amount of hydrogen included in the BOG is insufficient for power generation to occur in the fuel cell stack 30 only using the amount of generated BOG, power conversion efficiency may be very low, or power generation may not occur.

In such a case, as in the above-described embodiments, a method in which hydrogen and BOG are collected through the buffer tank 50, and the collected hydrogen and BOG are added to the fuel cell stack 30 to generate power may be used.

However, since the amount of BOG necessary to collect for efficient power generation is much more than the amount of generated BOG, in order to collect a large amount of BOG, it is necessary to increase the volume of the buffer tank 50 or store the BOG at a high pressure.

Here, when the volume of the buffer tank 50 is increased, since the buffer tank 50 occupies a large space, there is a problem in that space efficiency is significantly reduced.

Also, when hydrogen and BOG are stored at a high pressure using compression equipment such as a compressor, the volume of the buffer tank 50 itself may be reduced, but since a large amount of power is consumed by the compressor, energy efficiency is significantly reduced.

Therefore, in the present embodiment, the separate BOG-only fuel cell stack 80 is provided additionally to supply only the hydrogen and BOG collected in the buffer tank 50 to perform power generation, and in such a case, BOG power generation efficiency may be significantly increased compared to when the fuel cell stack 30 is operated alone.

Also, the present embodiment has advantages in that the heat exchanger 20, the pressure control device 60, and the temperature control device 70 may be utilized without change, and a separate supply line other than the hydrogen supply path 1 is not necessary.

In addition, the present embodiment has an advantage in that the buffer tank 50 may be utilized even in an unexpected situation in which hydrogen is oversupplied from the hydrogen tank 10 during traveling of a vehicle.

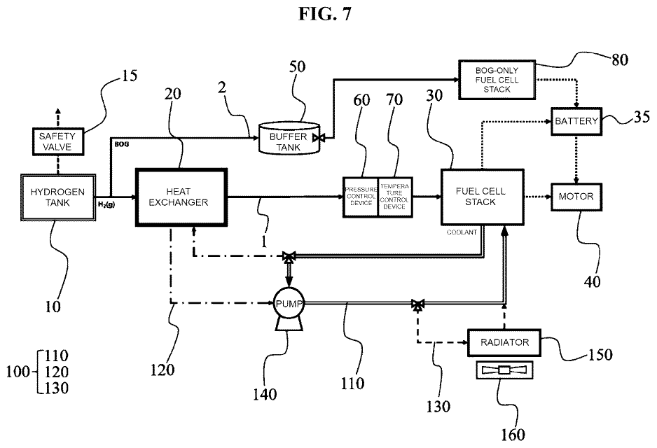

FIG. 7 is a view schematically illustrating an organic connection structure between components constituting a liquid hydrogen-based fuel cell power train system according to a third embodiment of the present invention.

The liquid hydrogen-based fuel cell power train system according to the third embodiment of the present invention illustrated in FIG. 7 further includes the BOG-only fuel cell stack 80 of the above-described second embodiment, in addition to including the basic components of the first embodiment.

However, the present embodiment is different from the second embodiment in that the branched path 2 does not supply hydrogen and BOG of the buffer tank 50 back to the hydrogen supply path 1, and the branched path 2 is connected to the BOG-only fuel cell stack 80 and directly supplies the hydrogen and BOG of the buffer tank 50 to the BOG-only fuel cell stack 80.

Therefore, in the present embodiment, in a case where the amount of hydrogen supplied from the hydrogen tank 10 is less than the amount of hydrogen used in the fuel cell stack 30, the BOG of the buffer tank 50 may be directly supplied from the buffer tank 50 to the BOG-only fuel cell stack 80.

Generally, in a situation in which a vehicle is stopped or the like, the amount of generated BOG is very small relative to hydrogen discharged during traveling of the vehicle, and thus, in such a case, it may be advantageous to configure a separate line for a flow of hydrogen and BOG as in the present embodiment.

Meanwhile, since the battery 35 has a limited capacity, when the battery 35 is fully charged, it is necessary to discharge the BOG to the outside, but this may cause a problem in terms of safety.

Therefore, in a case where the battery is fully charged with power generated from the BOG-only fuel cell stack 80, in the present embodiment, the above-described problem may be addressed by the power or hydrogen being consumed by a vehicle, or the power being transmitted to an external power source connected to the vehicle.

As a method of consuming power by a vehicle, a task of cleaning air inside and outside the vehicle, a task of pre-filtering air necessary for an operation of the fuel cell stack 30, and the like may be utilized.

That is, since clean air should enter a fuel cell, during an operation of the fuel cell, power may be consumed in a process of passing air through a filter, and purified air may be stored.

Also, as a method of consuming hydrogen by a vehicle, a method in which hydrogen is supplied to the fuel cell stack 30 and consumed may be utilized.

The fuel cell stack 30 needs to reach an operating temperature for power generation to be performed, but there is a problem in that the amount of BOG is small and the temperature of the fuel cell stack 30 cannot be increased. Therefore, when power generation is performed, only hydrogen may be consumed because the amount of power used to increase the temperature of the fuel cell stack 30 is larger than the amount of generated power.

Also, in a process in which hydrogen is consumed as above, when hydrogen flows in the fuel cell stack 30, this may also help extend the service life of the fuel cell stack 30.

Generally, the service life of a fuel cell is known to be reduced when a gas other than hydrogen is added to a hydrogen line while the fuel cell does not operate. Therefore, in the present embodiment, by letting hydrogen flow in the fuel cell stack 30 as described above, the reduction of the service life of the fuel cell stack 30 may be prevented.

Also, as a method of transmitting power to an external power source connected to the vehicle, a method in which residual power is sold to external electronic equipment, a building, or the like may be utilized.

In addition, in the present embodiment, in a case where a failure occurs in any one of the fuel cell stack 30 and the BOG-only fuel cell stack 80 in a process in which the two are operated together, the other one may be used to prevent a phenomenon in which the BOG is discharged.

Exemplary embodiments according to the present invention have been described above, but it should be obvious to those of ordinary skill in the art that the present invention may be embodied in specific forms other than the above-described embodiments without departing from the gist or scope of the present invention. Therefore, the above-described embodiments should be considered illustrative instead of limiting, and accordingly, the present invention is not limited to the above description and may be changed within the scope of the appended claims and their equivalents.

### DESCRIPTION OF THE REFERENCE

1: hydrogen supply path
2: branched path
10: hydrogen tank
15: safety valve
20: heat exchanger
30: fuel cell stack
35: battery
40: motor
50: buffer tank
60: pressure control device
70: temperature control device
80: BOG-only fuel cell stack
100: coolant circulation system
110: first cooling path
120: second cooling path
130: third cooling path
140: pump
150: radiator
160: blower fan

1. A liquid hydrogen-based fuel cell power train system comprising:
a motor configured to generate a driving force of a liquid hydrogen-based fuel cell power engine;
a fuel cell stack configured to convert chemical energy of hydrogen and oxygen into electrical energy and supply the electrical energy to the motor;
a hydrogen tank configured to accommodate hydrogen supplied to the fuel cell stack through a hydrogen supply path; and
a coolant circulation system including a plurality of cooling paths that cool the fuel cell stack and circulate a coolant, whose temperature has increased, to recool the coolant,
wherein the coolant circulation system performs switching control of the cooling paths, along which the coolant flows, to deal with an operational situation of the fuel cell stack.

2. The liquid hydrogen-based fuel cell power train system of claim 1, further comprising:
a heat exchanger configured to perform a heat exchange between the hydrogen supplied to the fuel cell stack and the coolant circulating through the coolant circulation system; and
a radiator configured to dissipate heat of the coolant circulating through the coolant circulation system to the outside.

3. The liquid hydrogen-based fuel cell power train system of claim 2, wherein the coolant circulation system includes:
a first cooling path configured to allow a coolant that has passed through the fuel cell stack to circulate without passing through the heat exchanger and the radiator;
a second cooling path configured to allow the coolant circulating through the first cooling path to circulate by passing through the heat exchanger; and
a third cooling path configured to allow the coolant circulating through the first cooling path to circulate by passing through the radiator.

4. The liquid hydrogen-based fuel cell power train system of claim 3, wherein, in a case where a coolant that has passed through fuel cells is able to maintain a temperature in a reference temperature range through cooling by natural cooling of the liquid hydrogen-based fuel cell power engine, the coolant circulation system supplies the coolant at a first flow rate and controls the coolant to circulate only through the first cooling path or controls the coolant to circulate through the first cooling path and the second cooling path.

5. The liquid hydrogen-based fuel cell power train system of claim 4, further comprising a temperature control device configured to control a temperature of the hydrogen supplied to the fuel cell stack through the hydrogen supply path,
wherein, in the case where the coolant is controlled to circulate only through the first cooling path, the temperature of the hydrogen is separately controlled through the temperature control device.

6. The liquid hydrogen-based fuel cell power train system of claim 3, wherein, in a case where the coolant that has passed through the fuel cells is not able to maintain a temperature in the reference temperature range through the heat exchanger and cooling by natural cooling of the liquid hydrogen-based fuel cell power engine, the coolant circulation system supplies the coolant at a second flow rate higher than the first flow rate and controls the coolant to circulate through the first cooling path, the second cooling path, and the third cooling path.

7. The liquid hydrogen-based fuel cell power train system of claim 3, wherein:
the radiator includes a blower fan; and
in a case where the coolant that has passed through the fuel cells is not able to maintain a temperature in the reference temperature range through the heat exchanger, the radiator, and cooling by natural cooling of the liquid hydrogen-based fuel cell power engine, the coolant circulation system supplies the coolant at a third flow rate higher than the second flow rate and drives the blower fan while controlling the coolant to circulate through the first cooling path, the second cooling path, and the third cooling path.

8. The liquid hydrogen-based fuel cell power train system of claim 1, further comprising a pressure control device configured to control a pressure of the hydrogen supplied to the fuel cell stack from the hydrogen tank.

9. The liquid hydrogen-based fuel cell power train system of claim 1, further comprising:
a branched path branched from the hydrogen supply path; and
a buffer tank provided in the branched path to store hydrogen and a boil-off gas (BOG).

10. The liquid hydrogen-based fuel cell power train system of claim 9, wherein, in a case where an amount of hydrogen supplied from the hydrogen tank is larger than an amount of hydrogen used in the fuel cell stack, the excess hydrogen is controlled to flow to the branched path and be stored in the buffer tank.

11. The liquid hydrogen-based fuel cell power train system of claim 9, wherein, in a case where an amount of hydrogen supplied from the hydrogen tank is less than an amount of hydrogen used in the fuel cell stack, the deficient hydrogen is controlled to be supplied from the buffer tank to the hydrogen supply path.

12. The liquid hydrogen-based fuel cell power train system of claim 9, further comprising a BOG-only fuel cell stack configured to convert chemical energy of hydrogen and oxygen into electrical energy using the BOG stored in the buffer tank and supply the electrical energy to the motor.

13. The liquid hydrogen-based fuel cell power train system of claim 12, wherein, in a case where an amount of hydrogen supplied from the hydrogen tank is less than an amount of hydrogen used in the fuel cell stack, the BOG of the buffer tank is supplied to the hydrogen supply path and then supplied to the BOG-only fuel cell stack.

14. The liquid hydrogen-based fuel cell power train system of claim 12, wherein:
the branched path is directly connected from the buffer tank to the BOG-only fuel cell stack; and
in a case where an amount of hydrogen supplied from the hydrogen tank is less than an amount of hydrogen used in the fuel cell stack, the BOG of the buffer tank is directly supplied from the buffer tank to the BOG-only fuel cell stack.

15. The liquid hydrogen-based fuel cell power train system of claim 1, further comprising a battery configured to supply electrical energy to the motor together with the fuel cell stack,
wherein the fuel cell stack allows excess electrical energy to be supplied to the battery and stored.
